(19) United States
(12) Patent Application Publication
(10) Pub. No.: US 2008/0171140 A1
(43) Pub. Date: Jul. 17, 2008

(54) Thin Film Ferroelectric Composites and Method of Making and Using the Same

(76) Inventors: Gerhard Hirmer, Aurora (CA); Qin Zou, Toronto (CA); George Xing, Markham (CA)

Correspondence Address: JONES & SMITH, LLP, 2777 ALLEN PARKWAY, SUITE 800, HOUSTON, TX, 77019-2141, US

(21) Appl. No.: 10/591,505

(22) PCT Filed: Mar. 3, 2005
(86) PCT No.: PCT/IB05/00546

§ 371 Date: Oct. 9, 2007

Related U.S. Application Data
(60) Provisional application No. 60/549,716, filed on Mar. 3, 2004.

(51) Int. Cl. B05D 5/12; B32B 9/00

(52) U.S. Cl. 427/100; 428/221

(57) ABSTRACT

Thin film ferroelectric structures having a top thin film layer prepared from a precursor solution containing a polymeric heterocyclic amide, such as polyvinylpyrrolidone. The polymeric heterocyclic amide improves top contact adhesion.

### FIELD OF THE INVENTION

The present invention relates to ferroelectric thin film composites having improved top contact adhesion which have particular applicability in capacitors.

### BACKGROUND OF THE INVENTION

Sol-gel coating is a technique for depositing thin films at relatively low temperatures. Such techniques, which may be used to produce piezoelectric thin films, minimize thermal expansion from a mismatch between a dielectric coating and substrate. In piezoelectric thin films, it is not uncommon for cracks to result in the composite when sol-gel processing is used.

Attempts have been reported in literature relating to the formation of barium titanate and lead zirconate titanate films, fabricated from solutions containing polyvinyl pyrrolidone, for use as crack-free piezoelectric thick films. See, for instance, Kozuka, H., and Kajimura, M., “Single-Step Dip Coating of Crack-Free BaTiO₃ Films>1 Micro Meter Thick: Effect of Poly(vinylpyrrolidone) on Critical Thickness”, Journal of the American Ceramic Society, vol. 83 (5), pp. 1056-1062, 2000; Kozuka, H., Takenaka, S., Tokita, H., Hirano, T., Higashi, Y., Hamatani, T., “Stress and Cracks in Gel-Derived Ceramic Coatings and Thick Film Formation”, Journal of Sol-Gel Science and Technology, vol. 26 (1-3), pp. 681-686, 2003; and Kozuka, H., Higuchi, A., “Single-Layer Submicron-Thick BaTiO₃ Coatings from Poly(vinylpyrrolidone)-Containing Sols: Gel-to-Ceramic Film Conversion, Densification, and Dielectric Properties”, Journal of Materials Research, vol. 16 (11), pp. 3116-3123, 2001. Such publications disclose that incorporation of polyvinylpyrrolidone in solutions for sol-gel processing reduce crack formation during heating as well as tensile stress in heat-treated barium titanate films. Further, Yu, S., Yao, K., Shannigrahi, S., and Hock, F. T. E, “Effects of Poly(ethylene glycol) Additive Molecular Weight on the Microstructure and Properties of Sol-gel-derived Lead Zirconate Titanate Thin Films”, Journal of Materials Research, vol. 18(3), pp. 737-741, 2003 discloses the use of lead zirconate titanate thin films incorporating polyethylene glycol in sol-gel precursor solutions to render crack-free films.

The procedures of the prior art, while reporting the formation of crack-free piezoelectric thick films, are not directed to the production of ferroelectric thin film layer devices, such as capacitors, which exhibit reduced leakage current and uniform electrical and mechanical properties. Such uniform properties are necessary with ferroelectric thin film capacitors in order to prevent poor adhesion of the top metal contact.

Methods of developing crack-free ferroelectric thin film composites and capacitors which exhibit a reduction in leakage current, uniformity across the capacitor and top contact adhesion are therefore desired.

### SUMMARY OF THE INVENTION

The invention relates to a method of forming ferroelectric thin film composites having improved top contact adhesion using low temperature sol-gel techniques. Each of the dielectric layers of the composite is preferably polycrystalline or nanocrystalline.

The ferroelectric thin film composites of the invention may be prepared by depositing onto a substrate, preferably by sol-gel techniques, a precursor composition for a first thin film layer. The precursor composition contains an organic solvent and organometallic compounds. The coated substrate is then heated until a first thin film layer is obtained.

Prior to depositing the first precursor composition onto the substrate, it may be preferable to deposit, preferably by sol-gel techniques, a buffer precursor composition onto the substrate. The buffer composition may contain a polymeric heterocyclic amide, such as polyvinylpyrrolidone.

A second precursor composition for a second thin film layer is then deposited onto the first thin film layer. The precursor composition for the second (i.e., top or contact) thin film layer contains organic solvent, a polymeric heterocyclic amide and organometallic compounds. Upon deposition, the composite is heated until a porous thin film layer is obtained. The amount of porosity of the resulting porous thin layer is dependent upon the ratio of metal to polymeric heterocyclic amide in the second precursor composition.

The resulting product is then annealed and a patterned thin metal layer may be formed. A top contact may then be formed onto the second thin film.

The optional buffer layer has a thickness between from about 40 nm to about 300 nm. The total thickness of the first thin film layer, which may be composed of one or multiple layers, is between from about 50 nm to about 900 nm, the thickness of the first thin film layer being greater than that the thickness of the buffer layer, when present. The thickness of the second thin film layer is between from about 40 to about 300 nm.

Suitable low temperature sol-gel coating techniques include spin-coating, dip-coating, spray coating, meniscus coating, flow coating, physical vapor deposition (PVD) and metal organic chemical vapor deposition (MOCVD).

The ferroelectric thin film capacitors formed in accordance with the invention exhibit improved top contact adhesion due to the presence of the polymeric heterocyclic amide in the second precursor composition. The improved top contact adhesion of the porous structure may also be attributable to an increased surface area.

### BRIEF DESCRIPTION OF THE DRAWINGS

In order to more fully understand the drawings referred to in the detailed description of the present invention, a brief description of each drawing is presented, in which:

FIG. 1 is a schematic diagram of a structure composed of a crystalline dielectric thin films deposited on a metallic foil, according to the present invention.

FIG. 2 is a flow chart diagram showing steps of manufacturing a ferroelectric thin film capacitor, according to the present invention.

FIG. 3 demonstrates the relationship of pore size to the metal:polyvinylpyrrolidone ratio.

FIG. 4 is a scanning electron microscope (SEM) micrograph illustrating the ferroelectric film morphology of composites prepared in accordance with the invention.

### DETAILED DESCRIPTION OF THE PREFERRED EMBODIMENTS

Structures derived from the composites of the invention are especially suitable in device applications such as thin film capacitors, ferroelectric memory devices, pyroelectric sensor devices, waveguide modulators and acoustic sensors. Such devices exhibit improved electrical characteristics. For instance, when used in capacitors, the ferroelectric thin film composites render reduced leakage current and improved top contact adhesion, yield and uniformity.

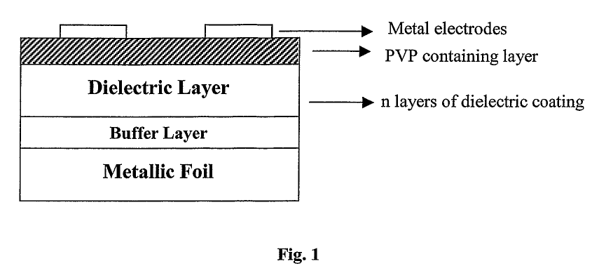

The thin film ferroelectric devices, set forth in FIG. 1, may be prepared by depositing onto a substrate, a precursor composition for a first dielectric thin film layer, a second thin film layer and an optional buffer layer. Each of the layers is preferably prepared from a precursor composition using sol-gel techniques. Suitable low temperature sol-gel coating techniques include spin coating, dip coating, spray coating, meniscus coating, flow coating, physical vapor deposition (PVD), and metal organic chemical vapor deposition (MOCVD).

The first thin film precursor composition contains an organic solvent and organometallic components capable of forming the desired inorganic oxide dielectric. The coated substrate is then heated until a dielectric thin film layer is obtained. In a preferred embodiment, the mixture is mixed at approximately 110° C. for about 90 minutes.

The buffer precursor composition contains an organic solvent and organometallic compounds. After deposition, the composition is heated, prior to applying the precursor for the first dielectric thin film layer, to remove the organic components and to render a dense buffer layer on the substrate. Typically, the composition is baked at a temperature from about 100° C. to about 450° C. and for a duration of about one to ten minutes. The organometallic compounds in the buffer precursor composition form, upon heating, inorganic oxides which, while exhibiting dielectric properties, provide improved attachment and bonding of the first dielectric thin film layer onto the substrate. The inorganic oxide of the buffer layer may be those recognized in the art. The buffer precursor composition may optionally contain a polymeric heterocyclic amide (such as polyvinylpyrrolidone). The optional buffer layer has a thickness between from about 40 nm to about 300 nm. The buffer layer may serve as a barrier against mechanical stress and failure from the substrate.

The first dielectric layer may be composed of one or more dielectric layers wherein each layer is deposited and heated prior to deposition of the next layer. Thus, the first dielectric layer, as that term is used herein, may consist of multiple layers. The precursor composition for each of the layers is preferably the same. When composed of multiple layers, the dielectric layers may be in a regular or irregular superlattice structure. The total thickness of the first dielectric thin film layer is between from about 50 nm to about 900 nm. The total thickness of the first dielectric thin film layer is generally greater than the thickness of the buffer layer, when present. Thickness may be controlled by rotation rate and the viscosity of the precursor composition.

A second precursor composition for a second (or contact) thin film layer is then sol-gel deposited onto the first dielectric thin film layer. The second thin film layer contains organic solvent, a polymeric heterocyclic amide and organometallic compound. Upon deposition, the composite is heated at approximately 110° C. until a porous thin film layer is obtained. The thickness of the second thin film layer is between from about 40 to about 300 nm. The amount of porosity of the porous thin layer is dependent upon the ratio of titanium, niobium, or tantalum metal in the precursor composition to polymeric heterocyclic amide. Preferably the molar ratio of polymeric heterocyclic amide to metal in the precursor composition is between from about 0.1 to about 1.0. By changing the polymeric heterocyclic amide to metal ratio, it is possible to change the density and size distribution of the pores. Thus, changing this ratio can modify essentially the total surface area of a given layer obtained from the precursor composition.

The precursor composition of the buffer layer, first dielectric thin film layer, and/or second thin film layer may further contain a stabilizing amount of a glycol, such as polyethylene glycol.

The resulting product is annealed and a patterned thin metal layer may then be formed. The onset of the ferroelectric transition depends on the annealing temperature. Thus, the product is annealed at elevated temperature until crystallization. Generally, the annealing conditions will be selected to increase the grain size of the substrate comprising the thin film composite as well as to induce a textured condition in the substrate. Annealing may proceed in an oven at a temperature of from about 500° C. to about 850° C. for approximately one hour or by rapid thermal annealing using quartz halogen lamps, laser-assisted annealing using, for example, an excimer or carbon dioxide laser, or using electron beam annealing. Subsequent annealing, in turn, enhances the texture and degree of crystallinity of the dielectric thin film. The resulting porous structure provides an increased surface area and thus improves adhesion. Annealing further promotes film crystallinity.

The inorganic oxide of the optional buffer layer, first dielectric thin film layer or second thin film layer are typically composed of the same elements although the ratio of the elements may be different. In a preferred embodiment, the inorganic oxide of the first dielectric thin film layer and the second thin film layer are identical. Each of the film layers is preferably polycrystalline or nanocrystalline film.

Exemplary as the inorganic oxide of either the buffer, first dielectric thin film layer, or second thin film layer is lead lanthanide titanate, lead titanate, lead zirconate, lead magnesium niobate, barium titanate, lead zirconate titanate, barium strontium titanate, lanthanum-modified lead zirconate titanate, bismuth zinc niobate and bismuth strontium tantalite. Preferred oxides are lead zirconate titanate, barium strontium titanate, lanthanum-modified lead zirconate titanate, bismuth zinc niobate and bismuth strontium tantalite.

Especially preferred are those titanates of the formula PbZr₁₋ₓTiₓO₃ family with 0<x<1; preferred are those of the formula PbZrₓTixO₃ wherein x is between from about 0.30 to about 0.70, more preferably between from about 0.35 to about 0.65. Especially preferred as barium strontium titanates are those of the formula (Ba₁₋ₓSrₓ)TiO₃ wherein 0≦x≦1.0, most preferably wherein x is between from about 0.1 to about 0.9, most preferably 0.3 to about 0.7. One preferred embodiment is represented by the formula Ba_{0.5}Sr_{0.5}TiO₃, Especially preferred as lanthanum-modified lead zirconate titanates are those of the formula Pb_{y}La_{z}(Zr₁₋ₓTiₓ)O₃, wherein x is from about 0.30 to about 0.70, preferably between from about 0.35 to about 0.65, y is from 0.95 to about 1.25, and z is from about 0 to about 0.15. Further preferred as bismuth zinc niobates are those of the formula Bi₃ₓZn₂₍₁₋ₓ₎Nb₂₋ₓO₇ wherein x is from about 0.40 to about 0.75; and bismuth strontium tantalates of the formula SrₓBi_{y}Ta₂O_{5+x+3y/2} wherein x is from about 0.50 to about 1.0 and y is from about 1.9 to about 2.5.

Suitable substrates of the thin film composite include semiconductor, glass and metallic foils, preferably metallic foils. Suitable semiconductor substrates include a Group 12-16 element such as silicon, SiGe and GaAs. Preferred as metallic foils are nickel alloys, aluminum, brass, titanium, nickel-coated copper, platinum, stainless steel, platinum-plated silicon and nickel-coated copper foils.

The constituency of the organometallic components in the precursor composition is dependent on the desired dielectric film. Typically the titanium, niobium and tantalum elements of the dielectric originate from a metal alkoxide, such as titanium isopropoxide. The remaining metals are typically derived from metal acetates. For instance, the precursor solution of the buffer layer may be prepared by using starting materials containing the requisite amounts of barium, strontium, lead, and lanthanum precursors, such as barium acetate, strontium acetate, lead acetate, lanthanum isopropoxide, titanium isopropoxide, and polyvinylpyrrolidone.

The organic solvent used in the precursor compositions is typically a glycol, such as ethylene glycol and propylene glycol, or an alkanol, such as ethanol, isopropyl alcohol, methanol and n-butanol, or weak organic acids, such as acetic acid.

In the sol-gel process, a non-aqueous solution of reactants is reacted at the desired stoichiometry and controllably hydrolyzed with a solvent/water solution. A thin, adherent film of the hydrolyzed alkoxide solution (“sol”) is then applied to the substrate at 1,000 to 3,000 rpm. It is most preferred that all reactants used in each of the alternative processes be of high purity. Generally, the level of purity is greater than 90%, preferably greater than 95%, and most preferably greater than 99%. In addition, it is preferred that the individual steps of the invention be conducted in a nitrogen-free atmosphere, preferably under vacuum.

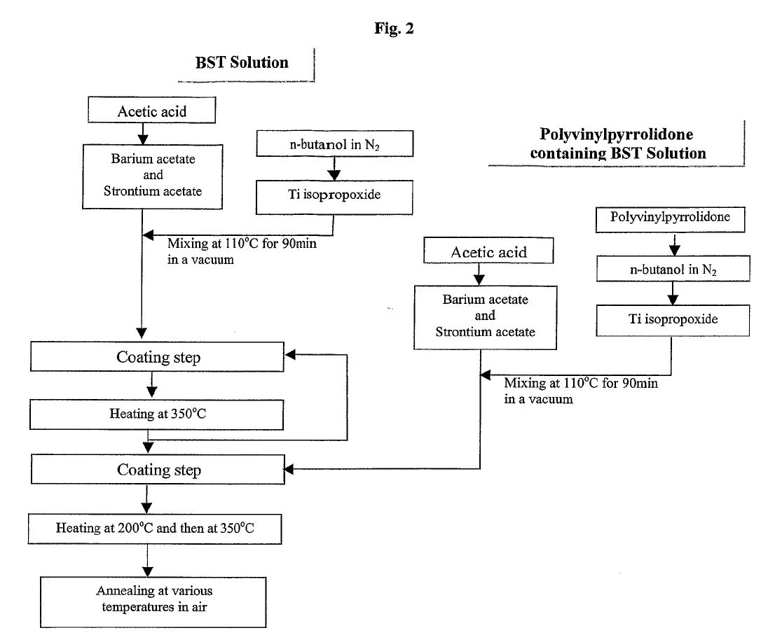

FIG. 2 illustrates an exemplary process for a composite barium strontium titanate as the dielectric layer. Barium acetate and strontium acetate are dissolved in the acetic acid and the solution is mixed at elevated temperature. In a second vessel is stirred an alkanol and titanium alkoxide and the resulting solution is then stirred, typically for an additional one to two hours. The solution is then introduced to the barium strontium solution. The resulting solution is then coated onto a suitable substrate for a suitable time to achieve uniform deposition of coating, such as spin coating. Typically, the spin coating proceeds through two stages. In the first stage, the solution is spin coated at a speed of about 2000 rpm, typically for about 10 seconds. In the second stage, the solution is spin coated onto the substrate at a speed of approximately 4000 rpm, typically for about 10 seconds. Alternatively, the substrate may be dipped into the above-described solution for coating of the thin film.

In separate vessels, acetic acid is introduced to barium acetate and strontium acetate (in one vessel) and polyvinylpyrrolidone, alkanol and titanium alkoxide (in a second vessel). The second vessel is mixed with the contents from the first vessel. The resulting solution is heated and applied onto the first thin film. The product is then heated and annealed.

Formation of the relatively thin electrode layer onto this second layer includes two steps. In the first step, the porous thin film layer is made conductive by coating it with Ni, Cu, Au, Ag, Si, Al, or Pd. The composite is then immersed in an appropriate solution and subsequently electroplated to form a top metal contact.

Ferroelectric thin film capacitors having a patterned thin metal layer and formed by the sol-gel precursor solutions exhibit, for instance when used in capacitors, reduced leakage current and improved top contact adhesion, yield and uniformity across the capacitor. Such improvements are due to the presence in the structure of the layer prepared from the precursor composition containing the heterocyclic amide polymer and dielectric forming sol. The deposition of the second precursor composition containing the polymeric heterocyclic amide further provides increased surface area which thereby improves adhesion.

The capacitors have particular applicability in the semiconductor industry especially in the construction and manufacturing of integrated circuits. In addition, it may be used by hybrid semiconductor manufacturers using discrete dielectrics and storage systems on or off the hybrid template. It may be further be used by printed circuit board manufacturers for the purposes of embedding large value capacitance in multilayer boards. Still further it may be used by (i.) communications industry in portable, cellular phones and critical systems power backup (such as emergency generators); (ii.) military sector usage in advanced guidance systems, controls, targeting and tracking systems or any application requiring backup power sources or highly condensed electronics; or (iii.) electric vehicles, land, sea, air and/or space as the primary backup or initiating power source.

The resulting composite showed significant improvements in current voltage, breakdown strength, leakage current density and loss tangent. For instance, the presence of the buffer layer in the composite of the invention reduces statistical average of leakage current density and narrows distribution of leakage current density due to uniformity.

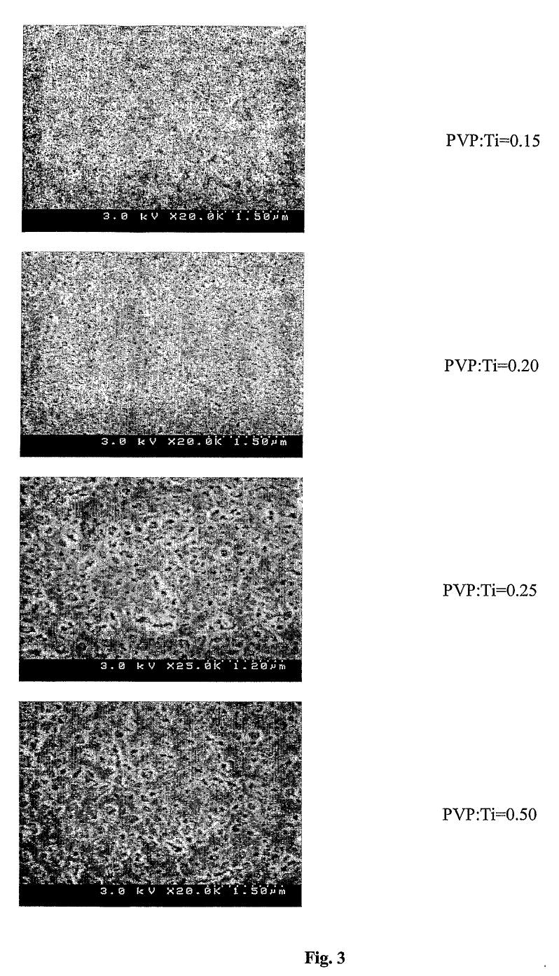

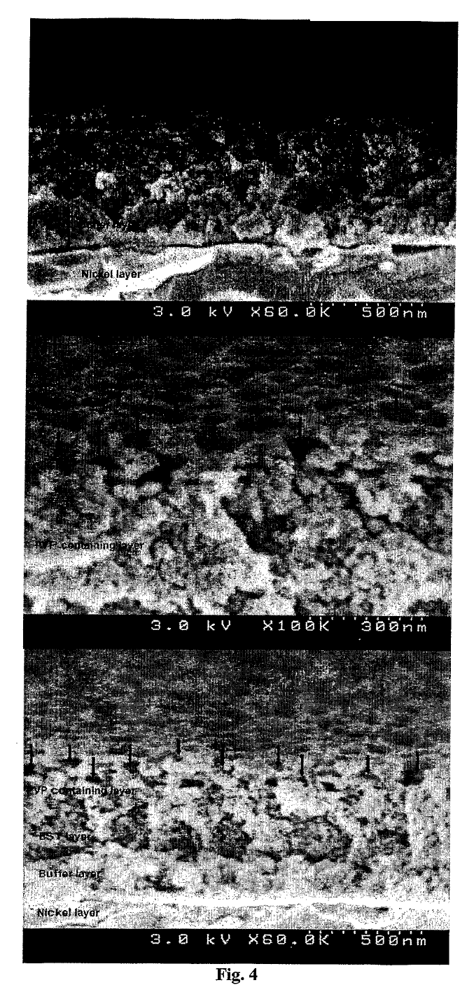

Improvements may be noted in FIG. 4 which presents a scanning electron microscope (SEM) micrograph of a Ba_{0.5}Sr_{0.5}TiO₃ ferroelectric film structure incorporating a buffer layer prepared from a Ba_{0.5}Sr_{0.5}TiO₃ precursor composition containing polyvinylpyrrolidione. The composite was prepared in accordance with the methodology set forth in FIG. 2. Each of the buffer layer, first thin film layer and second thin film layers was prepared from a Ba_{0.5}Sr_{0.5}TiO₃ precursor composition. The film was annealed at 600° C. in air. FIG. 4 presents a SEM of the morphology of the ferroelectric film. The relationship of the pore size to ratio of Ti:PVP in the dielectric solution is evident in FIG. 3 wherein the polyvinylpyrrolidone content in the dielectric is changed from 0.15 to 0.50. The size of the micropores change with the polyvinylpyrrolidone content in the solution. Thus, the size of the pores can be controlled by the polyvinylpyrrolidone content in the dielectric solution.

The above describes the practice of the present invention in its preferred embodiments. Other embodiments within the scope of the claims herein will be apparent to one skilled in the art from consideration of the specification and practice of the invention as disclosed herein. It is intended that the specification be considered exemplary only, with the scope and spirit of the invention being indicated by the claims which follow.

1. A method of making a multi-layer ferroelectric thin film composite: which comprises:
(A.) depositing onto a substrate a first precursor composition for a first dielectric thin film layer and heating for a time sufficient to render a first dielectric thin film layer; and
(B.) depositing onto the first dielectric thin film layer a second precursor composition for a second thin film layer comprising an organic solvent, a polymeric heterocyclic amide and organometallic compound and heating for a time sufficient to render a porous thin film layer, wherein the amount of porosity of the porous thin layer is dependent upon the ratio of organometallic compound to polymeric heterocyclic amide in the second precursor composition; and
(C.) annealing the product of step (B.).

2. The method of claim 1, further comprising, prior to depositing the first precursor composition onto the substrate, depositing onto the substrate a buffer precursor composition comprising an organic solvent and organic metallic compounds, and then heating to obtain a composite of a buffer layer and substrate.

3. The method of claim 2, wherein the thickness of the buffer layer is up to 300 nm.

4. The method of claim 2, wherein the buffer layer further comprises a polymeric heterocyclic amide.

5. The method of claim 1, wherein the product of step (C.) is annealed at a temperature between from about 550° C. to about 750° C.

6. The method of claim 1, wherein the first dielectric thin film layer has a thickness between from about 50 to about 900 nm.

7. The method of claim 6, wherein the second thin film layer has a thickness between from about 40 to about 300 nm.

8. The method of claim 1, wherein the porosity of the second thin film layer is controlled by the molar ratio of metal:polyvinylpyrrolidone.

9. The method of claim 1, wherein some of the elements in the first dielectric thin film layer and second thin film layer are the same.

10. The method of claim 1, wherein the first dielectric thin film layer and/or second thin film layer is selected from the group consisting of a lead lanthanide titanate, lead titanate, lead zirconate, lead magnesium niobate, barium titanate, lead lanthanum zirconate titanate, lead zirconate titanate, barium strontium titanate, lanthanum-modified lead zirconate titanate, bismuth zinc niobate and bismuth strontium tantalite.

11. The method of claim 10, wherein the first dielectric thin film layer and/or second thin film layer comprises lead zirconate titanate, barium strontium titanate, lanthanum-modified lead zirconate titanate, bismuth zinc niobate and/or bismuth strontium tantalite.

12. The method of claim 11, wherein the first dielectric thin film layer and/or second thin film layer are of the formula (Ba₁₋ₓSrₓ)TiO₃, PbZr₁₋ₓTiₓO₃ or Pb_{y}La_{z}(Zr₁₋ₓTiₓ)O₃ wherein x is between from about 0.1 to about 0.9, y is from about 0.95 to about 1.25 and z is between from about 0 to about 0.15.

13. The method of claim 12, wherein x is between from about 0.30 to about 0.70.

14. The method of claim 11, wherein the first dielectric thin film layer and/or second thin film layer are of the formula Bi₃ₓZn₂₍₁₋ₓ₎Nb₂₋ₓO₇ wherein x is between from about 0.40 to about 0.75.

15. The method of claim 11, wherein the first dielectric thin film layer and/or second thin film layer are of the formula SrₓBi_{y}Ta₂O_{5+x+3y/2} wherein x is between from about 0.50 to about 1.0 and y is between from about 1.9 to about 2.5.

16. The method of claim 1, wherein the substrate is selected from the group consisting of a semiconductor, glass or a metallic foil.

17. The method of claim 16, wherein the semiconductor contains a Group 12-16 metal and the metallic foil is selected from the group consisting of aluminum, brass, nickel alloy, nickel-coated copper, platinum, titanium and stainless steel foil.

18. The method of claim 1, wherein the first dielectric thin film layer is composed of several dielectric layers in a regular or irregular superlattice structure.

19. The method of claim 1, wherein at least one of the first dielectric thin film layer or second thin film layer is formed by the deposition of a composition containing polyethylene glycol.

20. The method of claim 1, further comprising forming a relatively thin electrode layer on top of the porous layer.

21. The method of claim 20, wherein the electrode layer comprises Ni, Cu, Au, Ag or Pd.

22. A method of making a multi-layer ferroelectric thin film composite which comprises:
(A.) depositing onto a substrate a precursor composition for a buffer layer and heating until forming a buffer layer having a thickness between from about 0 to about 300 nm;
(B.) depositing onto the buffer layer a second precursor composition for a first dielectric thin film layer and heating until a dielectric thin film layer having a thickness of from about 50 to about 900 nm is formed, the thickness of the first dielectric thin film layer being greater than the thickness of the buffer layer; and
(C.) depositing onto the first thin film layer a third precursor composition containing polyvinylpyrrolidone for a second thin film layer and heating until a porous thin film layer having a thickness of from about 40 to about 300 nm is formed; and
(D.) annealing the product of step (C.) at a temperature between from about 550° C. to about 750° C.

23. A method of making a multi-layer, thin film composite which comprises:
(A.) sol-gel depositing onto a substrate a precursor composition for a buffer layer, the precursor composition comprising an organic solvent and organic metallic compounds;
(B.) heating the product of step (A.) to render a composite of a buffer layer and substrate;
(C.) sol-gel depositing onto the product of step (B.) a precursor composition for a first thin film layer comprising an organic solvent and organometallic compounds;
(D.) heating the product of step (C.) to render a composite wherein the buffer layer is between the substrate and the first thin film layer and wherein the thickness of the first thin film layer is greater than the thickness of the buffer layer;
(E.) sol-gel depositing onto the product of step (D.) a precursor composition for a second thin film layer comprising an organic solvent, a polymeric heterocyclic amide and organometallic compounds;
(F.) heating the product of step (E.) to render a composite wherein the first thin film layer is between the buffer layer and the second thin film layer and further wherein the second thin film layer is porous; and
(G.) annealing the product of step (F.).

24. The method of claim 23, wherein the polymeric heterocyclic amide is polyvinylpyrrolidone.

25. The method of claim 23, wherein the buffer layer of step (B.) has a thickness from 0 to about 300 nm.

26. A ferroelectric thin film capacitor, memory device, pyroelectric sensor device, wave guide modulator or acoustic sensor containing the multi-layer thin film composite of claim 1.

27. The method of claim 23, wherein some of the elements in the buffer layer, first dielectric thin film layer, and second thin film layer are the same.
